(19) United States
(12) Patent Application Publication
(10) Pub. No.: US 2006/0133477 A1
(43) Pub. Date: Jun. 22, 2006

(54) Combined video decoder and watermark creator

(76) Inventors: Junbiao Zhang, Bridgewater, NJ (US); Kumar Ramaswamy, Princeton, NJ (US); Jun Li, Middlesex, NJ (US); Jill MacDonald Boyce, Monmouth, NJ (US)

Correspondence Address: THOMSON LICENSING INC., PATENT OPERATIONS, PO BOX 5312, PRINCETON, NJ, 08543-5312, US

(21) Appl. No.: 10/524,906

(22) PCT Filed: Aug. 19, 2003
(86) PCT No.: PCT/US03/25834

§ 371 Date: Feb. 17, 2005

Related U.S. Application Data
(60) Provisional application No. 60/404,884, filed on Aug. 21, 2002.

(51) Int. Cl. H04N 11/04; H04N 11/02; H04N 7/12; H04B 1/66

(52) U.S. Cl. 375/240.03; 375/240.25; 375/240.23; 375/240.12; 375/240.18; 375/240.24; 375/240.2

(57) ABSTRACT

A method and apparatus that inserts watermark signal into decoded video pictures where the watermark creation function is combined with the video decoder and makes use of compressed domain information to create a perceptually adaptive watermark signal.

This application claims the benefit of the U.S. Provisional Application No. 60/404/884 filed on Aug. 21, 2002.

### FIELD OF THE INVENTION

The present invention relates to digital media content protection, and more particularly, to a method of watermarking digital video data with perceptually adaptive watermark signals during the decoding process.

### BACKGROUND OF THE INVENTION

Digital media data content protection is a very significant problem facing content providers. Current content protection methods rely on encryption to protect the digital media data content with the assumption that only authorized users have the key to decrypt the encrypted digital media data content. However, this does not prevent the user from taking the unencrypted and uncompressed signal from the user's device and re-encoding it for illegal distribution. If pirating of digital media data content occurs, the content owners want to be able to identify the parties involved.

One method of copyright protection utilized in digital media industry is watermarking of the encoded digital media signal (e.g. video and/or audio signals). A watermark is a digital code embedded in the bit stream of the digital media signal which typically indicates the identity of the copyright owner. Watermarking the encoded digital media data content before broadcasting allows the content owner to identify their own material but does not provide information about which video decoder was used to pirate the digital media data content.

Adding a watermark at the consumer's video decoder system allows identification of the consumer's video decoder used in the piracy but such systems are computationally intensive, particularly when adding perceptually adaptive watermark signals. Thus, an improved video decoder system with a watermarking function for adding perceptually adaptive watermark signals is desired.

### SUMMARY OF THE INVENTION

According to an aspect of the present invention, there is disclosed a method of watermarking digital media data in a video decoder system wherein the watermark creation function is combined with the video decoder, and makes use of the media data content's compressed domain (i.e. the compressed bit stream) data to create perceptually adaptive watermark signals for watermarking the digital media data after it is decompressed and decoded.

A digital video signal decoder system according to an aspect of the present invention comprises the standard digital video decoding components: an entropy decoder for receiving a compressed encoded digital video signal and variable length decoding the encoded signal into a decoded bit stream; an inverse quantizer for dequantizing the decoded bit stream; an inverse block transform decoder for transforming the dequantized, decoded digital video signal into pixel information; a motion compensator for receiving the pixel information from the block transform decoder and providing a motion compensated data stream; and a summer for summing the pixel information and the motion compensated data stream. The video decoder system according to an aspect of the present invention also includes a watermark inserter that receives at least one piece of compressed domain information and generates a perceptually adaptive watermark signal that is embedded into the decompressed decoded video signal output of the video decoder system. The perceptually adaptive watermark signal's strength is derived from the at least one piece of compressed domain information. The at least one piece of compressed domain information may be extracted from the entropy decoder, the inverse quantizer, or the summer.

The watermark creation function may be added to a video decoder system, such as that in a digital set top box or a DVD player. The watermark creation function may be combined with any video decoding system that utilizes video compression standard using transform coding, such as MPEG-1/2/4, JVT/H.264/MPEG AVC, or H.263.

### BRIEF DESCRIPTION OF THE DRAWING

The invention will be better understood from the following detailed description of an exemplary embodiment thereof in conjunction with the accompanying drawing in which:

FIG. 1 is a schematic representation of a conventional video decoder; and

FIG. 2 is a schematic representation of a video decoder according to an embodiment of the present invention.

### DETAILED DESCRIPTION OF THE INVENTION

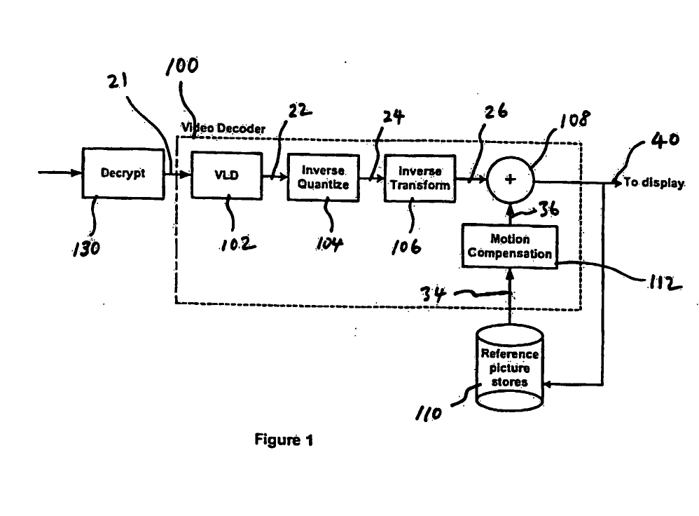

For purposes of comparison to the present invention, a standard video decoding system illustrated in FIG. 1 will be described. A compressed, encoded input signal 21 is received by the video decoding system 100 and goes to an entropy decoder 102 (e.g. a Huffman Decoder) which decodes the encoded input signal 21 into decoded bit stream 22. The decoded bit stream 22 is then dequantized by an inverse quantizer 104 into a dequantized code 24. The inverse block transform decoder 106 transforms the dequantized code 24 from the frequency domain to the spatial domain in fixed or variable size blocks, for example in 8×8 pixel units, into pixel information 26. In certain applications, the encoded input data 21 may be decrypted first by a decryption unit 130.

The system also includes a motion compensator 112 for receiving reference pictures (I-pictures or B-pictures) from reference picture storage 110 and generating motion compensated predicted pictures 36 for return to a summer 108. The pixel information 26 from the inverse block transform decoder 106 is added to the predicted pictures 36 from the motion compensator 112 by the summer 108, if required. The output of the summer 108 are the pixels of the decoded picture. The resulting output signal 40 from the summer 108 may then be either stored in a memory unit (not shown) or to a display unit (not shown).

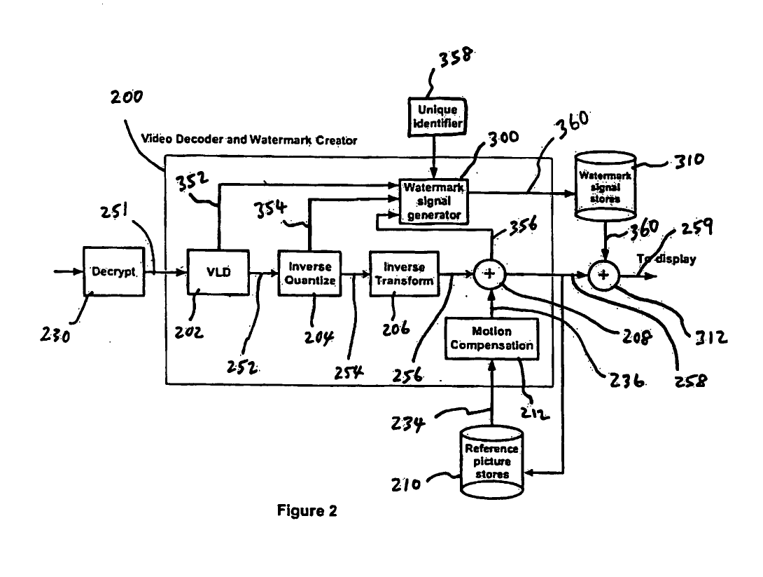

A video decoding system 200 according to an embodiment of the present invention is illustrated in FIG. 2. The video decoding system 200 includes the standard decoding functional units: an entropy decoder 202; an inverse quantizer 204; an inverse block transform decoder 206; a reference picture storage 210; a motion compensator 212; and a summer 208. A compressed, encoded input signal 251 is received by the video decoding system 200 and goes to an entropy decoder 202 for variable length decoding of the encoded input signal 251 into decoded bit stream 252. The decoded bit stream 252 is then dequantized by an inverse quantizer 204 into a dequantized code 254. The inverse block transform decoder 206 transforms the dequantized code 254 from the frequency domain to the spatial domain in fixed or variable size blocks, for example in 8×8 pixel units, into pixel information 256. In certain applications, the encoded input data 251 may be decrypted first by a decryption unit 230. The motion compensator 212 receives reference pictures (i.e., I-pictures or P-pictures for MPEG-1 or MPEG-2) from the reference picture storage 210 and generates motion compensated predicted pictures 236 for return to a summer 208. The pixel information 256 from the inverse block transform decoder 206 is added to the motion compensated predicted pictures 236 from the motion compensator 212 by the summer 208, if required. The output of the summer 208 are the pixels of the decoded picture. The resulting output signal 258 from the summer 208 may then be either stored in a memory unit (not shown) or to the next destination, such as a display unit (not shown) or a video recorder (not shown).

In addition to these standard decoding units, the video decoding system 200 of the present invention includes a watermark signal inserter comprising a watermark signal generator 300, watermark signal storage unit 310 (e.g. a memory unit such as a RAM device) and a watermark adder 312. The watermark signal generator 300 transforms a unique identifier information 358 into a watermark signal 360 for insertion into a video output signal 258 by the watermark adder 312. The unique identifier information 358 is typically information that would help identify the content of the watermarked video output signal 259 as to its copyright ownership, scope of the copyright license, the copyright licensee, etc. The unique identifier information 358 may also include a device specific indicator that will identify the particular video decoder system 200, such as a unique identification or a serial number assigned to the video decoder system 200.

The watermark signal generator 300 is linked to the decoding units, the entropy decoder 202, the inverse quantizer 204, and the summer 208 and can accept compressed domain information from any one or all three of these linked decoding units. The watermark signal generator 300 uses the compressed domain information to optimize the strength of the watermark signals it generates so that they are perceptually adaptive in reference to the video signal being decoded by the video decoder system 200.

For example, the compressed domain information extracted from the entropy decoder 202 may be a count of the number of coded (non-zero) transform coefficients for the data blocks in the bit stream. The watermark signal generator 300 may use this information to optimize the strength of the watermark signals 360 that may be inserted into decompressed decoded output signal 258 in the spatial domain. Higher numbers of coded coefficients indicate a higher activity level for the block indicating that a higher strength watermark signal 360 may be inserted into the corresponding blocks in the decompressed decoded output signal 258. The strength of the watermark signal is proportional to the activity level of the block.

The compressed domain information extracted from the inverse quantizer 204 may be the values of non-DC transform coefficients of the dequantized code. The watermark signal generator 300 could sum the absolute values of the non-DC transform coefficients or the squares of the non-DC transform coefficients. A higher sum indicates a higher activity level for the block, indicating that a higher strength watermark signal may be inserted into the corresponding blocks in the decompressed decoded output signal 258. In other words, the strength of the watermark is proportional to the activity level of the block.

The compressed domain information extracted from the summer 208 output may be the absolute luminance DC values of the data blocks. The absolute luminance DC value of the data blocks can be derived from the video decoding process by adding the luminance delta DC value coded in the bit stream to a luminance DC predictor. Higher luminance values indicate that a higher strength watermark signal may be inserted. Alternatively, the difference in luminance DC values between two adjacent data blocks may be used to optimize the strength of the watermark signal. If the difference between the luminance DC value of a data block and the luminance DC value of its adjacent data blocks is high, a higher strength watermark signal may be inserted into that data block. Thus, the strength of the watermark signal may be proportional to the difference between the luminance values of the data block and its neighboring blocks.

In another embodiment of the present invention, a local perceptually adaptive watermark signal could be applied individually to each transform coefficient of a block based on the transform coefficients of that block and the perceptual slack for that coefficient. Human Visual System properties such as the just noticeable difference (JND) values for a particular coefficient of a particular block could be used to calculate an individual coefficient's slack, and hence its corresponding watermark signal's strength. Activity measures and luminance values may also be used to adjust the strength of a watermark signal applied to individual transform coefficients. The video decoder's inverse transform function could be used for converting the transform-domain watermark signal to the spatial domain. In yet another embodiment, if deblocking filtering is applied within the compression processing, for example the MPEG4-AVC video standard, the deblocking filter strength used for a particular block transition could be used to select the locally adaptive watermark signal strength. Blocks with stronger deblocking filter strength would be able to accommodate higher strength watermark signals.

The watermark signal generator 300 may use one or more of the compressed domain information 352, 354, and 356 from the entropy decoder 202, the inverse quantizer 204, and the summer 208, respectively, to obtain the desired perceptually adaptive watermarking result.

The watermark signals 360 may be stored in watermark signal storage unit 310 and made available to the watermark adder 312 for insertion into the video output signal 258. The resulting watermarked video signal 259 may be transmitted to a display (not shown), a video encoder (not shown) or a video recorder (not shown). Preferably, the watermarked video signal 259 is the only output signal made available as output of the video decoding system 200 ensuring that any video data recorded from the video decoding system 200 will be watermarked as a deterrent to any copyright infringement of the content of the video signal.

In the embodiments of the present invention discussed above, the perceptually adaptive watermark signals are generated contemporaneously during the video signal decoding process. Alternatively, several watermark signals of varying strengths may be pre-generated and stored in watermark signal storage unit 310 and a watermark signal of appropriate strength may be selected based on the compressed domain information extracted from the various decoding units discussed above. For example, using the compressed domain information extracted from the entropy decoder 202, the number of coded (non-zero) transform coefficients for a data block could be compared to several threshold values and determine which of the several pre-stored watermark signals is appropriate for that data block. Higher threshold values would correspond to higher activity levels for the data block and would result in higher strength watermark signals being applied to higher activity blocks. The thresholds could be different for intra, inter, and bi-directionally or bi-predictively coded blocks.

In another embodiment of the present invention, the pre-stored watermark signals may use spread spectrum technique applied unevenly to the coded transform coefficients. For example, one of several pre-stored watermark signals could be selected based on comparing the absolute luminance DC value of the block to several thresholds. In another embodiment of the present invention, the activity levels (represented by the number of coded transform coefficients) and the luminance DC values may be combined in a joint thresholding method to select from the pre-stored watermark signals.

In the embodiments of the present invention discussed above, the watermark signals are either newly generated or selected from several pre-stored watermark signals contemporaneously during the video decoding process and then inserted into the output signal 258 of the video decoder 200 as the output signal 158 is transmitted by the video decoder 200 to the next destination, which may be a display (not shown) or another video processing device such as a Video Cassette Recorder (not shown). According to another aspect of the present invention, the watermark signals 360 generated contemporaneously for reference pictures may be stored in the watermark signal storage unit 310 and then inserted into the video output signal 258 as the video output signal is transmitted to the next destination. Because the watermark signals are stored in the spatial domain, the watermark signal storage unit 310 may require additional capacity. If the video compression standard used allows different display and coding order of pictures, for example using B-pictures, the spatial-domain watermark signal must be stored for each reference picture. The video decoder requires the storage of the decoded reference pictures that have not been watermarked for use in forming predictions in the decoding process of later coded pictures. An appropriate memory device such as a RAM device or a hard disk drive may be provided for this purpose. When the display of a particular decoded picture is delayed until other pictures have been decoded, the watermark signals generated using compressed domain information from the decoding process are stored in the watermark signal storage unit 310. Prior to display, the watermark signal is added to the decoded picture.

According to yet another aspect of the present invention, the information used to generate the watermark signals for the reference pictures may be stored rather than storing the spatial-domain watermark signals. Then when the video output signal 258 is ready to be transmitted, watermark signals can be generated and inserted into the video output signal 258. This will reduce the storage capacity requirement for the watermark signal since the information used to generate the watermark signals is smaller amount of data than the spatial-domain watermark signals.

The decoder system of the present invention can be included in a stand-alone system, as a separate unit (e.g. a set-top box). Alternatively, the decoder system can be integrated into a television set, a computer, a DVD player, or other video device.

While the foregoing invention has been described with reference to the above embodiments, various modifications and changes can be made without departing from the spirit of the invention. Accordingly, all such modifications and changes are considered to be within the scope of the appended claims.

1. A digital video signal decoding system comprising:
a video signal decoder for decoding a compressed encoded digital video signal during which at least one piece of compressed domain information is generated; and
a watermark inserter for generating a watermark signal whose strength is derived from the at least one piece of compressed domain information.

2. A digital video signal decoding system of claim 1, wherein the video signal decoder comprises:
an entropy decoder for receiving a compressed encoded digital video signal and providing a decoded bit stream thereof;
an inverse quantizer for dequantizing the decoded data from the entropy decoder into dequantized code;
an inverse block transform decoder for transforming the dequantized code into pixel information;
a motion compensator for receiving the pixel information from the block transform decoder and providing a motion-compensated predicted-picture data stream; and
a summer for summing the motion-compensated predicted-picture data stream and the pixel information into a decompressed decoded video output signal.

3. The digital signal decoder system of claim 1, wherein the watermark inserter comprises:
a watermark signal generator for creating a watermark signal; and
an adder for adding one of the plurality of pre-generated watermark signals to the decompressed decoded video output of the digital signal decoder system.

4. The digital signal decoder system of claim 1, wherein the watermark inserter comprises:
a watermark signal generator for creating a watermark signal;
a memory unit for storing a plurality of pre-generated watermark signals, and
an adder for adding one of the plurality of pre-generated watermark signals to the decompressed decoded video output of the digital signal decoder system.

5. The digital signal decoder system of claim 2, wherein the at least one piece of compressed domain information is provided by the entropy decoder.

6. The digital signal decoder system of claim 5, wherein the at least one piece of compressed domain information is a count of the number of coded transform coefficients in the decoded bit stream's data blocks.

7. The digital signal decoder system of claim 2, wherein the at least one piece of compressed domain information is provided by the inverse quantizer.

8. The digital signal decoder system of claim 7, wherein the at least one piece of compressed domain information are values of non-DC transform coefficients in the dequantized code.

9. The digital signal decoder system of claim 2, wherein the at least one piece of compressed domain information is provided by the output of the summer.

10. The digital signal decoder system of claim 9, wherein the at least one piece of compressed domain information is absolute luminance DC values of data blocks in the pixel information.

11. A digital signal decoder system of claim 2, wherein the watermark signal contains a unique identifier information.

12. A digital signal decoder system of claim 11, wherein the unique identifier information includes information regarding a copyright license associated with the digital video signal's content.

13. A digital signal decoder system of claim 11, wherein the unique identifier information includes a device specific indicator that will identify the particular video decoder system.

14. A digital signal decoder system of claim 1, wherein the compressed encoded digital video signals are compressed utilizing a video compression standard from the group comprising MPEG-1, MPEG-2, MPEG-4, JVT, H.264, MPEG AVC or H.263

15. A method of watermarking a digital video signal comprising:
decoding a compressed encoded digital video signal into a decompressed decoded video output during which at least one piece of compressed domain information is generated;
generating a watermark signal whose strength is derived from the at least one piece of compressed domain information; and
adding the watermark signal to the decompressed decoded video output.

16. A method of claim 15, wherein the step of generating a watermark signal comprises:
receiving the at least one piece of compressed domain information at a watermark signal generator; and
determining the strength of the watermark signal to be generated based on selected attributes of the at least one piece of compressed domain information.

17. A method of claim 15, wherein the step of decoding a compressed encoded digital video signal includes receiving the compressed encoded digital video signal at an entropy decoder and providing a decoded bit stream thereof; and
the at least one piece of compressed domain information is a count of the number of coded transform coefficients in the decoded bit stream's data blocks.

18. A method of claim 15, wherein the step of decoding a compressed encoded digital video signal includes receiving the compressed encoded digital video signal at an entropy decoder and providing a decoded bit stream thereof; and
the at least on piece of compressed domain information is perceptual slack for the coded transform coefficients in the decoded bit stream's data blocks.

19. A method of claim 15, wherein the step of decoding a compressed encoded digital video signal includes:
receiving the compressed encoded digital video signal at an entropy decoder and providing a decoded bit stream thereof; and
dequantizing the decoded bit stream into dequantized code; and the at least one piece of compressed domain information are values of non-DC transform coefficients in the dequantized code.

20. A method of claim 15, wherein the step of decoding a compressed encoded digital video signal includes:
receiving the compressed encoded digital video signal at an entropy decoder and providing a decoded bit stream thereof;
dequantizing the decoded bit stream into dequantized code; and
transforming the dequantized code into pixel information; and
the at least one piece of compressed domain information is absolute luminance DC values of data blocks in the pixel information.

21. A method of claim 20, wherein the at least one piece of compressed domain information is the difference in luminance DC values between a data block and its neighboring data blocks.

22. A method of claim 15, wherein the step of decoding a compressed encoded digital video signal into a decompressed decoded video output includes generation of reference pictures for use in forming predictions of later coded pictures; and
storing the watermark signals in a first memory unit and storing the reference pictures in a second memory unit, wherein the step of adding the watermark signal to the decompressed decoded video output includes retrieving the stored watermark signals from the first memory unit.

23. A method of claim 15, wherein the watermark signal contains a unique identifier information.

24. A method of claim 23, wherein the unique identifier information includes information regarding a copyright license associated with the digital video signal's content.

25. A digital signal decoder system of claim 23, wherein the unique identifier information includes a device specific indicator that will identify the particular video decoder system.

26. A digital signal decoder system of claim 15, wherein the compressed digital video signal is compressed using a compression process applying deblocking filtering and the at least one piece of compressed domain information is the deblocking filtering strength for a particular block transition.

27. A method of watermarking a digital video signal comprising:
generating a plurality of watermark signals, each watermark signal having different strength;
storing the plurality of watermark signals in a memory unit;
decoding a compressed encoded digital video signal into a decompressed decoded video output during which at least one piece of compressed domain information is generated;
selecting a watermark signal from the plurality of watermark signals stored in the memory unit based on the at least one piece of compressed domain information; and
adding the selected watermark signal to the decompressed decoded video output.

28. A method of claim 27, wherein the watermark signal contains a unique identifier information.

29. A method of claim 28, wherein the unique identifier information includes information regarding a copyright license associated with the digital video signal's content.

30. A digital signal decoder system of claim 28, wherein the unique identifier information includes a device specific indicator that will identify the particular video decoder system.
